(19) United States
(12) Patent Application Publication
(10) Pub. No.: US 2004/0251741 A1
(43) Pub. Date: Dec. 16, 2004

(54) End connectors for crawler chains

(76) Inventors: Klaus Spies, Wald (DE); Norbert Steinebrunner, Radevormwald (DE); Bernd-Dieter Neubert, Remscheid (DE)

Correspondence Address: Leopold Presser, Scully Scott Murphy & Presser, 400 Garden City Plaza, Garden City, NY, 11530, US

(21) Appl. No.: 10/482,248

(22) PCT Filed: Jun. 15, 2002
(86) PCT No.: PCT/EP02/06624

(30) Foreign Application Priority Data
Jun. 23, 2001 (DE) 101-30-385.8

(51) Int. Cl. B62D 55/21

(52) U.S. Cl. 305/45

(57) ABSTRACT

In the case of narrow end connectors 13 due to handling errors at the clamping screw 30 there is the risk of the track coming apart due to end connectors 13 slipping off. That is prevented by inclinedly inserted transverse pin members 7. They bear at the outside against the clamping screw 30.

The invention concerns end connectors for caterpillar tracks as set forth in the classifying portion of claim 1.

DE 34 05 699 C2 discloses end connectors for caterpillar tracks, in which track link bodies are provided with rubber-mounted pins. The pins of adjacent track link bodies are connected together by the end connectors. The end connectors are in the form of closed elastic clips having two eyes for the pins and a slot which connects the eyes. The pins are to be screwed fast in the eyes of the end connectors by way of a clamping means such as a screw. The rubber mountings for the pins are pre-stressed. The pre-stressing of that rubber mounting arrangement is established by means of transverse pin members which are fixed in the pins and which engage into the slot. The transverse pin members are displaced laterally with respect to the screw, more specifically being arranged at the outside.

It has been found in practice that the screw prestressing force is reduced when handling errors occur. The risk of a track coming apart due to end connectors slipping off is great, particularly in the case of caterpillar tracks with only two end connectors on the track width. In order to prevent the end connectors from slipping off, the transverse pin members engage behind the screw in the region of the outside surface of the connectors.

In the case of end connectors of small width, the transverse pin members cannot serve as a means for preventing the connectors from slipping off as, for reasons of space, they cannot be arranged beside the screw.

The object of the invention is to secure very narrow end connectors to prevent them from slipping off the pins when there are handling errors at the screw. The width of the connectors approximately corresponds to the diameter of the pins.

The invention attains that object in accordance with the characterising features of claim 1 and alternatively by the characterising features of claim 2. Advantageous developments of the invention are set forth in the appendant claims.

Embodiments of the invention are illustrated in the drawing in which:

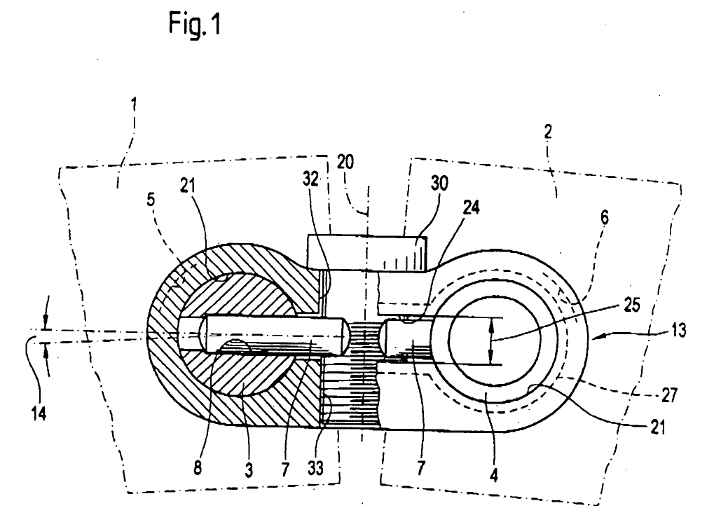

FIG. 1 is a partial view in section of a connector and a two-pivot pin track shown in simplified form,

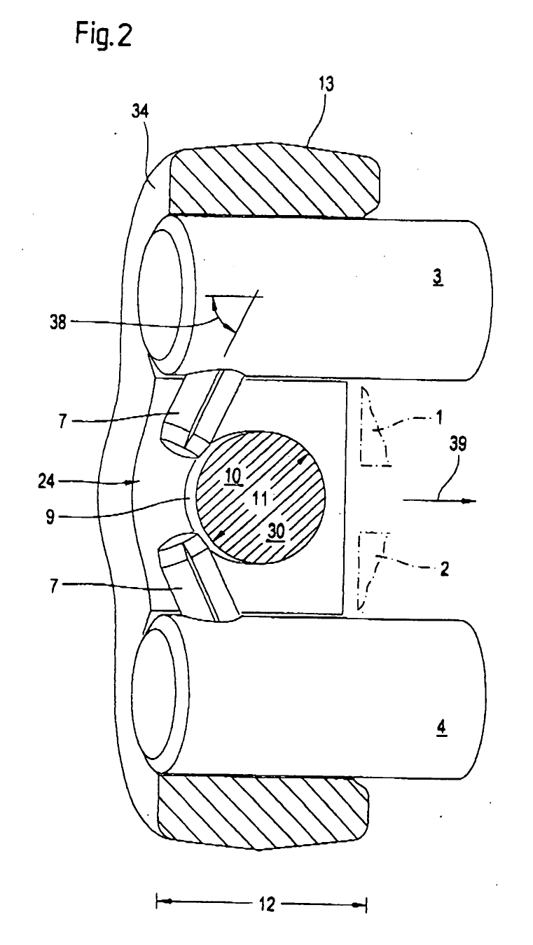

FIG. 2 shows an end connector with inclinedly inserted transverse pin members in the pins,

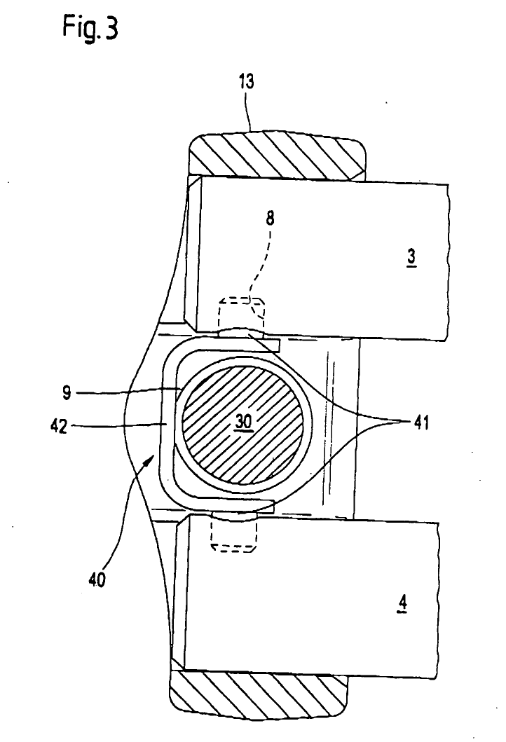

FIG. 3 shows an elastic stirrup with transverse pin members which are integrally connected thereto,

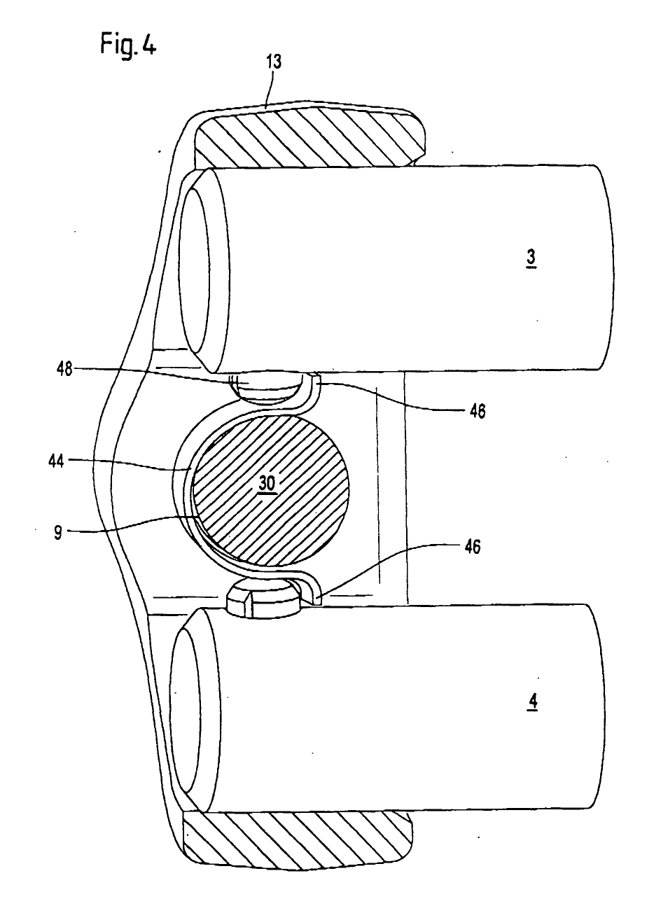

FIGS. 4-7 show stirrup securing arrangements,

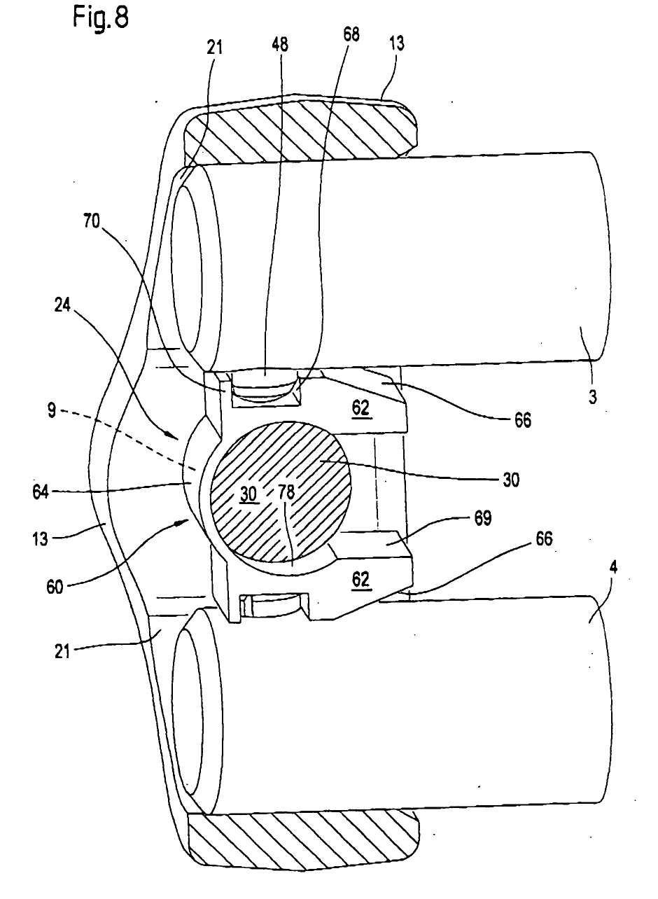

FIGS. 8-10 show shoe securing arrangements,

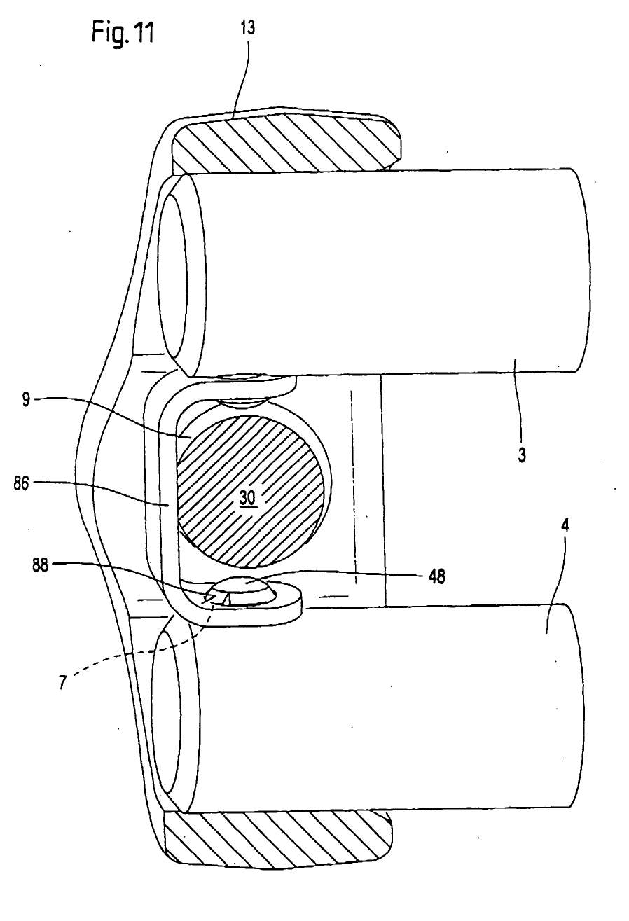

FIG. 11 shows a stirrup securing arrangement, and

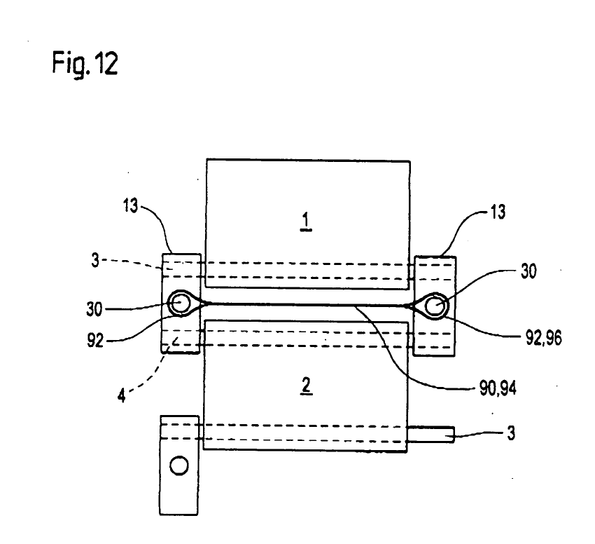

FIG. 12 shows a steel cable or steel plate securing arrangement.

Referring to FIG. 1, arranged in track link members 1 and 2 of a two-pivot pin track are pins 3 and 4 with known rubber bearings 5 and 6. The pins 3 and 4 of circular cross-sections are provided at their ends with transverse pin members 7. The pin members 7 are fitted in force-locking engagement in bores 8 in the pins 3 and 4.

A connector 13 is of a symmetrical configuration with respect to the axis 20. It has two eyes 21 which are connected by a slot 24 of a width 25. Provided on the axis 20 is a screwthread connection in the form of a screw 30, a bore 32 and a screwthreaded bore 33.

The transverse pin members 7 project into the slot 24, with a slight amount of lateral clearance. As shown in FIG. 2 those transverse pin members 7 are fixed inclinedly in the pins 3, 4 and are disposed between the screw 30 and the outside surface 34 of the connector 13.

Upon assembly of the connector 13, the pins 3 and 4, which are provided with the transverse pin members 7, of the track link bodies 1 and 2 are self-adjustingly oriented in relation to the bearing eyes 21 and the slot 24.

The rubber bearings 5 and 6 fix the pins 3 and 4 with the transverse pin members 7 in the track link bodies 1 and 2 in the illustrated position, corresponding to an assembly angle 14. That assembly angle 14 is a measurement in respect of the prestressing of the rubber bearing arrangements (not shown) in the track link bodies 1 and 2.

As shown in FIG. 2, the transverse pin members 7 are inserted inclinedly, from the ends of the pins 3, 4, more specifically at an angle 38 of 75°.

The connector 13 is pushed on to the pins 3, 4 in the direction indicated by the arrow 39. The screw 30 which is thereafter fitted in place fixes the pins 3, 4 in the connector 13 in force-locking or frictional engagement. The force-locking engagement is so designed that no relative movement of the pins 3, 4 takes place in the connector 13. The function of the transverse pin members 7 is to ensure the correct assembly position of the pins 3, 4 in the connector in accordance with the angle 14 and, in the event of handling errors in relation to the screw 30 or in the event of the screw 30 not being sufficiently tightened, to prevent the connector 13 from slipping off the pins 3, 4, in the opposite direction to the arrow 39. The transverse pin members 7 bear tangentially against the outside 9 of the screw 30.

The connector 13 is of an only slightly greater width 12 than the diameter 11 of the screw shank 10 of the screw 30. The arrangement therefore has only a small amount of usable space for the means according to the invention for preventing it from slipping off.

As shown in FIG. 3, provided on a stirrup 40 which is of an approximately right-angled configuration are transverse pin members 41 which are formed in one piece thereon.

The stirrup is fitted prior to insertion of the screw 30, by a procedure whereby the stirrup 40 is compressed until the transverse pin members 41 can be pressed into the bores 8. After insertion of the screw the stirrup 40 bears in a prestressed condition against the screw 30 in the region 42.

As shown in FIG. 4 a stirrup 44 embraces approximately half the periphery of the screw 30 and engages with hook-shaped projections 46 behind the transverse pin members 48.

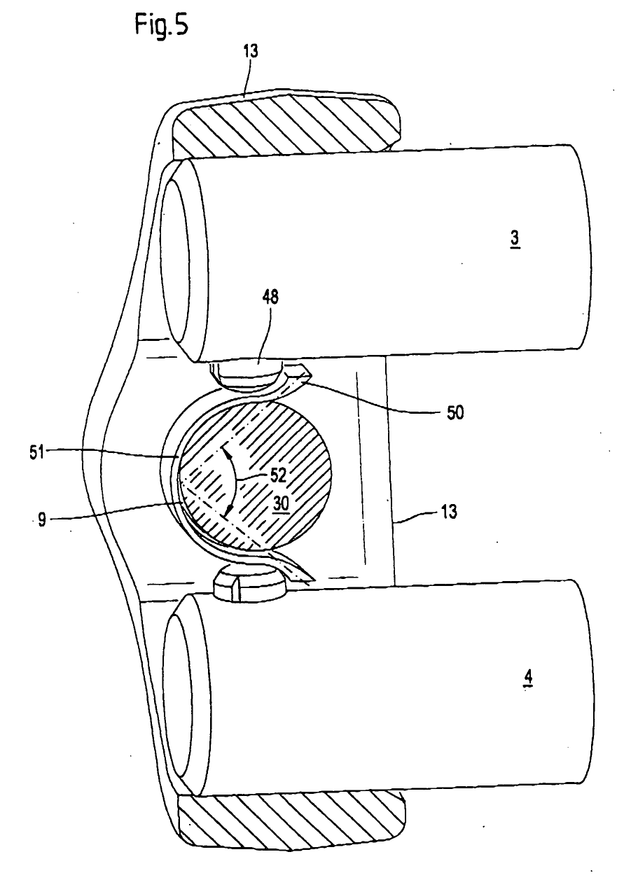

A variant in that respect can be seen in FIG. 5, wherein the hook-shaped projections 50 of a stirrup 51 form a V-shape 52.

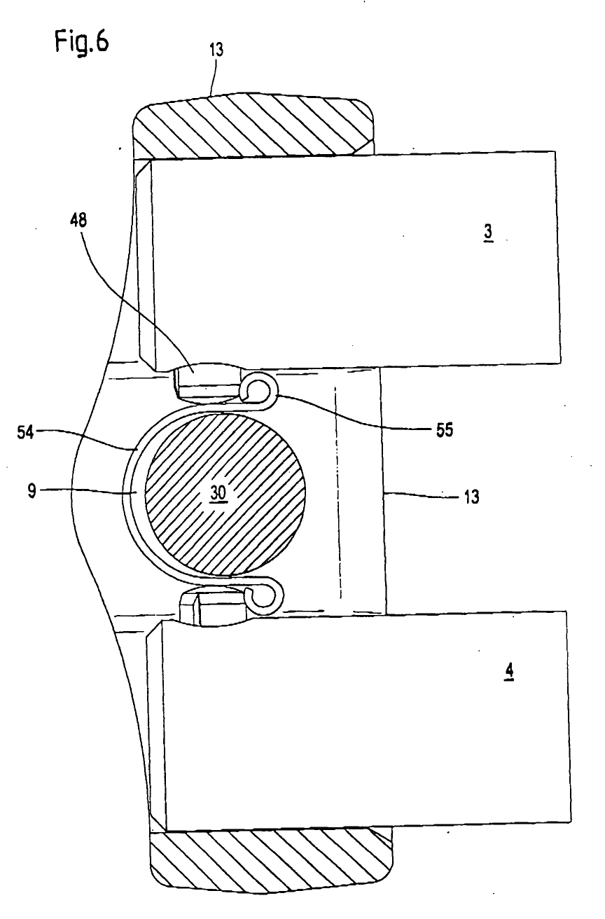

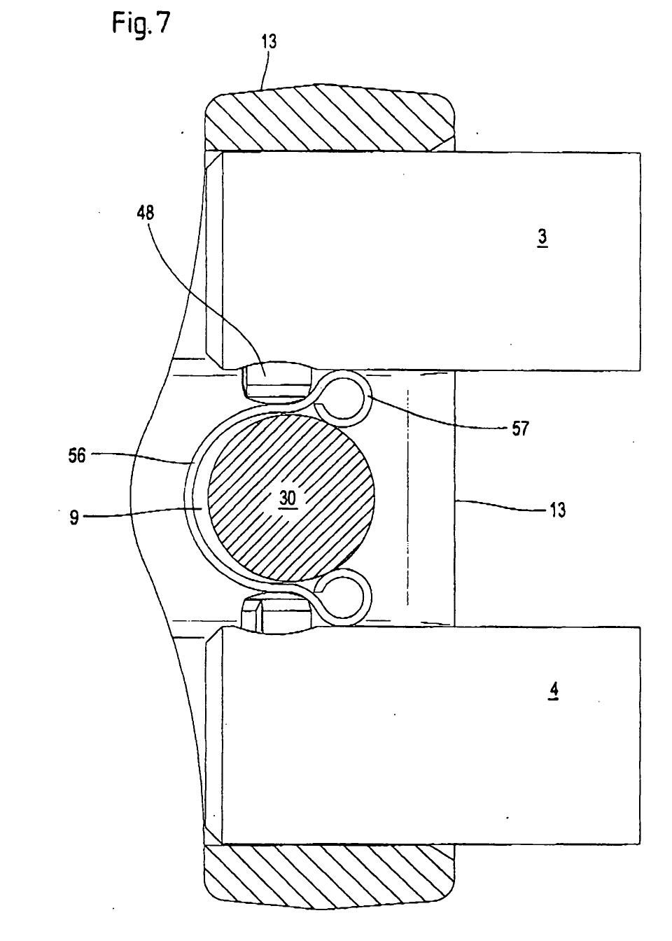

Stirrups 54, 56 with counterclockwise eyes 55, FIG. 6, and clockwise eyes 57, FIG. 7, secure the connectors 13. The eyes 55 bear at the track link body side against the transverse pin members, see FIG. 6, and, as shown in FIG. 7, both against the transverse pin members 7 and also against the screw 30.

An elastic shoe securing arrangement 60 can be seen in FIG. 8. Two shoes 62 are connected by way of an external elastic band portion 64. The shoes 62 each have an inclined run-on surface 66 and an opening 68 for receiving the transverse pin members 7. The shoe securing arrangement 60 comprises steel. For the assembly procedure, the shoe securing arrangement 60 is inserted into the slot 24 of the connector 13 and fitted into the end position illustrated, by being pressed into place. In that procedure, the inclined run-on surface 66 slides with the flat portion 69 on the transverse pin member 7. An abutment 70 secures the shoe securing arrangement 60 after it has been fitted on by resilient deformation. Both the shoe 62 and also the band portion 64 extend around the screw 30.

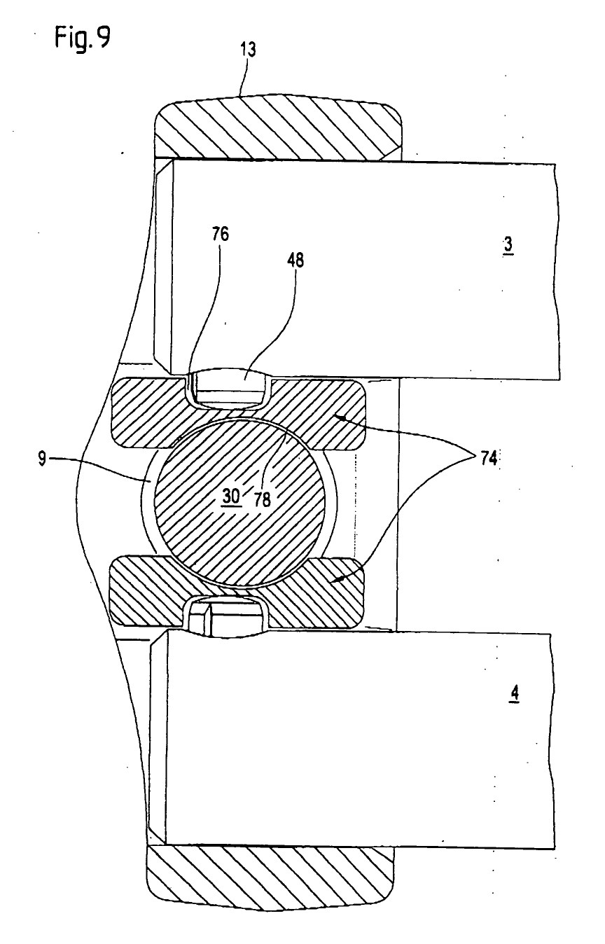

As shown in FIG. 9 there are two individual shoes 74 to provide the securing action. The shoe securing arrangements 74 accommodate the transverse pin member 7 in an opening 76 and bear with an arcuate configuration 78 against the screw 30.

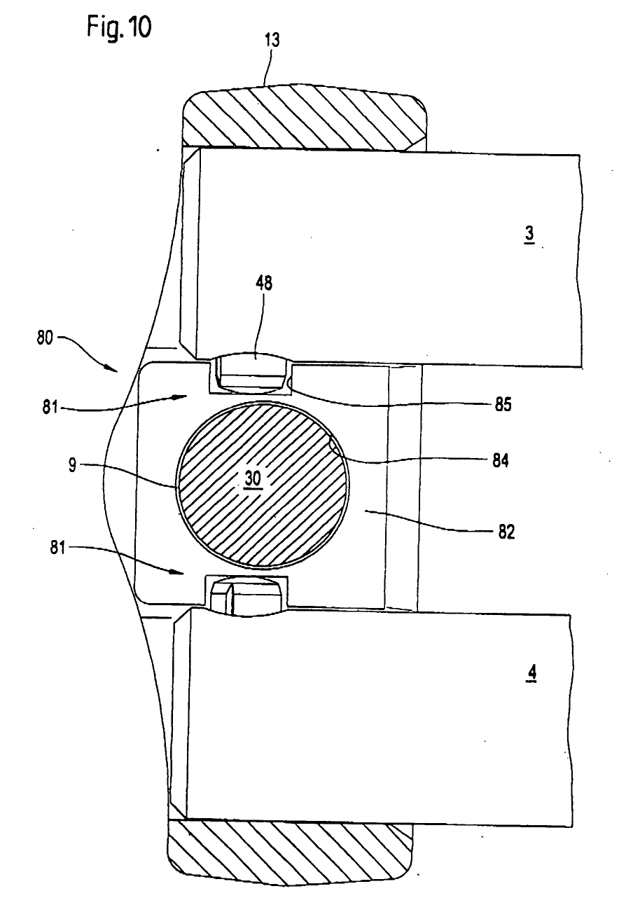

FIG. 10 shows a rigid shoe securing arrangement 80. Provided in an approximately square body 82 are a bore 84 for mounting the screw 30 and openings 85 for receiving the transverse pin members 7.

As shown in FIG. 11 an elastic stirrup 86 of steel with receiving bores 88 for the transverse pin members 7 is fitted in place.

What is common to the above-described securing arrangements is that, when the structure does not involve a fixed fit of the connector 13 on the pins 3 and 4, the loose connector 13 is held or bears against the described securing arrangements.

Another structure corresponding to FIG. 12 provides a securing action in the same manner, in which the screws 30 of the connectors 13 which are disposed at both sides of the track link bodies 1, 2 on the pins 3 and 4 are connected by a steel cable 90. Suitable loops 92 extend around the screws 30. As an alternative thereto, a further structure involves a sheet metal plate or bar 94 with corresponding eyes 96.

1. An end connector (13) for caterpillar tracks in which track link bodies (1, 2) are provided with rubber-mounted pins (3, 4), and
end connectors (13) connect the pins (3, 4) of adjacent track link bodies (1, 2),
the width of the end connectors (13) approximately corresponds to the diameter of the pins (3, 4),
wherein each end connector (13) is in the form of a closed elastic clip with two eyes (21) and a slot (24) connecting the eyes (21), and
has a clamping means such as a screw (30) which is disposed at a right angle with respect to the slot (24), and
wherein the slot (24) fixes transverse pin members (7) of the pins (3, 4) by positively locking engagement,
characterised in that the transverse pin members (7) secure the connector (13) by positively locking engagement from slipping off the pins (3, 4) directly by virtue of the arrangement of the transverse pin members or indirectly by way of at least one securing means (40, 44), wherein both the transverse pin members (7) and also the securing means lie within the contour of the connector (13).

2. An end connector according to claim 1 characterised in that the transverse pin members (7) are arranged inclinedly in the pins (3, 4) insofar as they bear approximately against the outside (9) of the screw (30).

3. An end connector according to claim 1 comprising transverse pin members (7) which are disposed approximately at a right angle to the pin axis in the pin (3, 4) or inclinedly disposed transverse pin members (7), characterised in that the transverse pin members (7) are connected to a securing means (42, 44, 51, 54, 56, 64, 74, 82, 86, 90, 94) which is arranged in the slot (24) and which embraces the screw (30) around at least half thereof.

4. An end connector according to claim 3 characterised in that the securing means is a stirrup (42) which is integrally connected to the two transverse pin members (41).

5. An end connector according to claim 3 characterised in that the securing means is a stirrup (44, 51, 54, 56) which engages behind the transverse pin members (7) in positively locking relationship with hook-shaped projections (40, 50) or eyes.

6. An end connector according to claim 3 characterised in that the securing means positively lockingly fixes both the transverse pin member or members (7) and also the screw (30) at the outside (9) thereof by way of shoes (62, 74, 80, 82).

7. An end connector according to claim 5 characterised in that the shoe securing means (60) has an external elastic band portion (64) which connects the shoes (62) together and the shoes (62) are provided with inclined run-on surfaces (66) and openings (68) for the transverse pin members (7).

8. An end connector according to claim 5 characterised in that there are provided two shoes (62) which are separate from each other.

9. An end connector according to claim 5 characterised in that shoe portions (81) are connected together at both sides and form a stiff body (82) with a bore (84) for mounting the screw (30).

10. An end connector according to claim 3 characterised in that the securing means fixes the screws (30) of two mutually oppositely disposed connectors (13) by a steel cable (90) or a steel plate (94) with eyes (92, 96).
